(19) United States
(12) Patent Application Publication
(10) Pub. No.: US 2014/0210949 A1
(43) Pub. Date: Jul. 31, 2014

(54) COMBINATION OF NARROW-AND WIDE-VIEW IMAGES

(71) Applicants: Erez Berkovich, Kfar Bialik (IL); Eyal Arad, Zichron Yaakov (IL)

(72) Inventors: Erez Berkovich, Kfar Bialik (IL); Eyal Arad, Zichron Yaakov (IL)

(73) Assignee: Rafael Advanced Defense Systems Ltd., Haifa (IL)

(21) Appl. No.: 14/238,740

(22) PCT Filed: Aug. 9, 2012
(86) PCT No.: PCT/IB2012/054056

§ 371 Date: Feb. 13, 2014

(30) Foreign Application Priority Data
Aug. 30, 2011 (IL) 214894

(51) Int. Cl. H04N 5/232; H04N 5/265; H04N 13/02

(52) U.S. Cl. CPC H04N 5/23296; H04N 13/0203; H04N 5/265
USPC 348/46; 348/239

(57) ABSTRACT

A dual field of view (FOV) image is generated as a combination of a small footprint image and large footprint image, where the large footprint image is generated based on rendering to the current viewpoint at least a first image captured relatively farther away from a target so as to appear as a continuation of a small footprint image which is relatively closer to the target. Preferably, both the first image and the small footprint image are captured with the same fixed narrow field of view (NFOV) imaging device. The system is able to operate in real time, using a variety of image capture devices, and provides the benefits of both NFOV and wide FOV (WFOV) without limitations of conventional techniques, including operation at a longer range from a target, with higher resolution, while innovative processing of the captured images provides orientation information via a dual FOV image.

### FIELD OF THE INVENTION

The present invention generally relates to the field of image processing, and in particular, it concerns combining narrow-view and wide-view images.

### BACKGROUND OF THE INVENTION

In a variety of applications, a sensor with a narrow field of view (NFOV) provides higher resolution, as compared to capturing the same target area with a comparable sensor having a wide field of view (WFOV). In particular, image capture devices such as video cameras using a NFOV are able to capture higher resolution images of a target area, as compared to a similar camera with a WFOV. Alternatively, a NFOV camera can capture a similar resolution image at a greater distance from a target compared to a WFOV camera. A significant trade-off in using a NFOV sensor is that using a NFOV sensor provides a smaller footprint, as compared to a WFOV sensor that provides a larger footprint of the target area. A larger footprint improves the ability of conventional systems to provide orientation information, including orientation of a user as the user approaches a target and/or orientation of the target in relation to the area surrounding the target.

To provide both images of larger footprints of the target area for orientation and images of smaller footprints of the target area for identification of the target, conventional systems use a variety of techniques, including using two or more sensors, one with a NFOV and another with a WFOV. Disadvantages of this technique include increased cost and weight due to multiple sensors. Another technique is to use a single sensor with both NFOV and WFOV capabilities, and to switch between the views as necessary. Disadvantages of this technique include increased system complexity and not being able to access simultaneous narrow and wide views of a target.

Customers desire to identify targets from as large a range as possible, which requires a sensor with a NFOV, while also being oriented to the area of the target, which is conventionally done using a WFOV.

There is therefore a need for a system and method where a single sensor can provide the benefits of both NFOV and WFOV without the limitations of conventional techniques.

### SUMMARY

According to the teachings of the present embodiment there is provided a method for generating an image of a target area, including the steps of: providing a plurality of images of the target area, wherein the plurality of images includes: at least a first image of the target area sampled at a first distance from an imaging device to the target area, the first image having a corresponding viewpoint; and a second image of the target area sampled at a second distance from the imaging device to the target area, the second distance being less than the first distance, the second image having a current viewpoint and a first field of view (FOV); and generating a dual field of view image as a combination of: the second image; and a generated large footprint image based on at least the first image rendered so as to appear as a continuation of the second image with the current viewpoint, the generated large footprint image having an effective FOV greater than the first FOV.

In an optional embodiment, the first image is sampled with a narrow field of view (NFOV) sensor and the second image is sampled with a NFOV sensor. In another optional embodiment, at least the first image and the second image are sampled using substantially the same field of view (FOV).

In an optional embodiment, each of the plurality of images is associated with a three-dimensional (3D) model of the target area and the step of generating a dual field of view image includes using the 3D model to provide the generated large footprint image. In another optional embodiment, the 3D model is generated from the plurality of images. In another optional embodiment, the 3D model is a pre-determined model of the target area. In another optional embodiment, the 3D model is a digital terrain map (DTM).

In an optional embodiment, an optical flow technique is used to derive an optical flow transform between the second image and the first image, and the step of generating a dual field of view image includes using the transform to provide the generated large footprint image.

In an optional embodiment, a first set of fiducial points in the first image are used with a second set of fiducial points in the second image to derive a mesh transform, and the step of generating a dual field of view image includes using the mesh transform to provide the generated large footprint image.

According to the teachings of the present embodiment there is provided a system for generating an image of a target area, including: an image source providing a plurality of images of the target area, wherein the plurality of images includes: at least a first image of the target area sampled at a first distance from an imaging device to the target area, the first image having a corresponding viewpoint; and a second image of the target area sampled at a second distance from the imaging device to the target area, the second distance being less than the first distance, the second image having a current viewpoint and a first field of view (FOV); and a processing system including at least one processor, the processing system configured to generate a dual field of view (FOV) image as a combination of: the second image; and a generated large footprint image based on at least the first image rendered so as to appear as a continuation of the second image with the current viewpoint, the generated large footprint image having an effective FOV greater than the first FOV.

In an optional embodiment, the image source includes a video camera capturing real-time images. In another optional embodiment, the image source includes a plurality of sensors. In another optional embodiment, the image source includes at least one image storage device.

In an optional embodiment, at least the first image is sampled with a narrow field of view (NFOV) sensor and the second image is sampled with a NFOV sensor. In another optional embodiment, at least the first and the second image are sampled using substantially the same field of view (FOV).

In an optional embodiment, the processing system is configured with an image association module that associates each of the plurality of images with a three-dimensional (3D) model of the target area, and the processing system is configured to generate the generated large footprint image using the 3D model. In another optional embodiment, the 3D model is generated from the plurality of images. In another optional embodiment, the 3D model is a pre-determined model of the target area. In another optional embodiment, the 3D model is a digital terrain map (DTM).

In an optional embodiment, the processing system is configured with an optical flow transform derivation module that derives an optical flow transform between the second image and the first image, and the processing system is configured to generate the generated large footprint image using the optical flow transform.

In an optional embodiment, the processing system is configured with a mesh transform derivation module that uses a first set of fiducial points in the first image are with a second set of fiducial points in the second image to derive a mesh transform, and the processing system is configured to generate the generated large footprint image using the mesh transform.

### BRIEF DESCRIPTION OF FIGURES

The embodiment is herein described, by way of example only, with reference to the accompanying drawings, wherein:

FIG. 1 is a diagram of sensor approaching a target.

FIG. 2A is a diagram representing a first image 200A captured with camera 100A from a corresponding viewpoint.

FIG. 2B is a diagram representing a second image 200B captured with camera 100B from a current viewpoint.

FIG. 2C is a representation of a dual FOV image 200C generated based on first image 200A and second image 200B.

FIG. 3 a flowchart of a method for generating an image of a target area.

FIG. 4, a diagram of a system for generating an image of a target area.

### DETAILED DESCRIPTION

The principles and operation of the system and method according to a present embodiment may be better understood with reference to the drawings and the accompanying description. A present embodiment is a system and method for combining small footprint images and large footprint images. In the context of this document, the term “small footprint image” generally refers to an image of a smaller region associated with a target as compared to a “large footprint image”. Small and large footprint images are also known in the field as narrow-view images and wide-view images, respectively. For clarity in this document, the terms small and large footprint images are generally used to refer to the images captured of relatively smaller and larger regions of a target area, and the terms narrow field of view (NFOV) and wide field of view (WFOV) are generally used to refer to the abilities and/or configuration of the sensor and/or image capture device.

The system is able to operate in real time, using a variety of image capture devices, and provides the benefits of both narrow field of view (NFOV) and wide field of view (WFOV) without limitations of conventional techniques. A NFOV image capture device facilitates operation at a longer range from a target, and provides higher resolution of the target area, as compared to a similar image capture device with a WFOV, while innovative processing of the captured images provides orientation information via a dual FOV image. A significant feature of the current embodiment is generation of a dual FOV image as a combination of a small footprint image and large footprint image, where the large footprint image is generated based on rendering to the current viewpoint at least a first image captured relatively farther away from a target so as to appear as a continuation of a small footprint image which is relatively closer to the target. In a preferred implementation both the first image and the small footprint image are captured with the same fixed NFOV imaging device. An alternative description of the current embodiment is generating a dual FOV image based on multiple images where each image has the same FOV, but the images are captured at different times, hence the images are captured with corresponding different distances between the image capture device and the target, and the images are at different spatial resolutions. In the context of this document, the term “spatial resolution” generally refers to the ability of any image-forming device to distinguish small details of an object. Spatial resolution is also known in the field as angular resolution.

In the context of this document, the term “rendering so as to appear as a continuation” generally includes a combination of image registration, correcting geometric deformations, and eliminating seams between combined images. Rendering so as to appear as a continuation includes finding corresponding pixels in a first image and a second image, and rendering the first image such that a resulting combined image (dual FOV image) includes a smooth transition from the second image that is embedded in the first image. The resulting combined dual FOV image provides an image similar to an image taken with a single high-resolution WFOV sensor relatively close to the target. It will be obvious to one skilled in the art that rendering so as to appear as a continuation may not require all of the above-listed processes, or may require additional processes, depending on the specific application.

The complexity of rendering so as to appear as a continuation depends on a variety of factors, as described below. As a camera gets closer to a target, the three-dimensional (3D) realities of the scene must be taken into account to produce an accurate combined image. In one implementation, while the camera is moving toward the target and capturing images, the images can be used to build a model of the target area. The model initially includes low-resolution information, and can be updated as subsequent captured images provide further and/or more detailed images of the target area. Captured images can be registered to the model and/or stored for future and/or additional registration. The model and registered images from corresponding viewpoints (viewpoints corresponding to previously captured images) can be used to generate a large footprint image of the target from a current viewpoint, which is then used to generate a dual FOV image of the target area.

In the context of this document, the term “target” generally refers to a location or item of interest, including but not limited to an area of interest or the center of a FOV. “Target area” generally refers to an area associated with a target, including but not limited to, area from a current location to a target location and an area around a target. “Viewpoint” generally refers to the three-dimensional location from which a target is being viewed and the direction in which the target is being viewed. “Field of view” (“FOV”) generally refers to the angular extent of the observable world that is seen at any given moment from an imaging sensor, or the area that is visible. A non-limiting description of FOV uses a solid angle from a viewing location toward a target. A “solid angle” is a three-dimensional (3D) angle formed at the vertex of a cone and/or the 3D angle from a viewing location toward a target. The area at a target location that is within the solid angle from a viewing location is the FOV from the viewing location to the target. The term “narrow FOV” (“NFOV”) generally refers to a FOV with a relatively smaller solid angle as compared to the solid angle of a “wide FOV” (“WFOV”). The difference between NFOV and WFOV (respectively below and above what angle or range of angles) depends on the application and components being used. In a non-limiting example, for imaging sensors used in aerial applications to capture images of the ground, NFOV is typically about 1 (one) degree, as compared to WFOV imaging sensors that typically capture in the range of 10 to 20 degrees. An imaging device with a NFOV typically provides a higher resolution image of the target (target area) as compared to the image of the same target area captured with a similar imaging device with a WFOV.

Note that, as is further described below, when an imaging device with a NFOV samples a first image of a target from a first distance from the imaging device to the target, the first image provides a large footprint image of the target area, as compared to the same imaging device sampling a second image of the target from a second distance that is relatively closer to the target (than the first distance). In this case, the second image provides a relatively small footprint image of the target. Hence, a NFOV camera provides a large footprint image of a target when far away, as compared to the same NFOV camera providing a small footprint image of the target when the camera gets closer to the target.

In the context of this document, the term “dual field of view” generally refers to an image, which is based on one or more small footprint images of a target combined with one or more large footprint images of the target. Note that the term “dual” in “dual field of view” refers to using two (or more) images to generate a single image for display, and should not be confused with displaying two or more images. For clarity, the term “corresponding viewpoint” is generally used to refer to a viewpoint corresponding to a previously captured image, while the term “current viewpoint” is used to refer to a viewpoint of a relatively more recently captured image (typically the most recently captured image). As will be described below in a preferred implementation, typically a previously captured image from a corresponding viewpoint is rendered so as to appear as a continuation of a recently captured image from the current viewpoint.

The dual FOV image of the present embodiment can alternatively be described as a virtual dual FOV image: A conventional dual FOV image combines a small footprint image captured with a NFOV sensor with a large footprint image captured with a WFOV sensor. In comparison, the current embodiment enables generation of a dual FOV image based on multiple images captured with a NFOV sensor, eliminating the need for an additional WFOV sensor.

In the current document, a preferred implementation is described with an image capture device as the sensor, in particular capturing (sampling) two-dimensional (2D) images. Although for simplicity and clarity the image capture device is generally referred to as a camera, the term “camera” should be interpreted as including alternative implementations including but not limited to still cameras, video cameras, image capture devices, and other sensors as appropriate for a specific application. It will be obvious to one skilled in the art that the current embodiment can be implemented with a variety of sensors, including but not limited to: visible, near infrared (NIR), infrared (IR), and laser detection and ranging (LADAR, or 3D imaging). In an alternative implementation, multiple sensors can be used, with each sensor capturing one or more images at various distances from a target. While the current embodiment is particularly useful in real-time applications, alternative embodiments include off-line processing and using stored data.

In addition to the conventional techniques described above, such as using multiple cameras or switching a single sensor between views, conventional processing techniques are known in the art for combining multiple images into a single image. One example is mosaicing, where multiple images of portions of a scene are “stitched” together to form a larger image of a scene. Registration and mosaicing of images can provide a constructed image of a scene from a pre-determined viewpoint. In this case, a viewpoint is chosen and subsequent images are transformed to match the pre-determined viewpoint. Popular transforms used for mosaicing include global transforms, such as affine, perspective and polynomial transformations, usually defined by a single equation and applied to the whole image (of a portion of the scene).

In a case where a camera is far away from a scene, the scene can be estimated as a planar view and global transforms can be used on the captured images to construct a larger combined (mosaiced) image of the scene. However, as a camera gets closer to a scene, the three-dimensional (3D) realities of the scene must be taken into account to produce an accurate combined image. Conventional global transforms are not sufficient for handling the 3D realities. While both a scene estimated as a planar view and a scene with 3D aspects need to have the images of the respective scenes processed to generate a combined image, for the later, the conventional family of global transforms does not produce combined images sufficiently accurate for user applications, and innovative processing is required. In addition, in applications where a detailed image is captured from a current viewpoint that is relatively closer to a target than a previous or pre-defined viewpoint (such as a large footprint image captured relatively farther away from a target), there is a desire to use the detailed image and match the large footprint image from a previous viewpoint to the current viewpoint.

Image capture for mosaicing is typically done with a camera that is at a substantially constant distance from a scene, and the camera moves in relation to the scene. A typical example is an airplane or satellite that flies at a fixed distance above a scene and captures images of different portions of the scene. In contrast, in a preferred implementation of the current embodiment, a camera moves in relation to a target, capturing images at varying distances that decrease as the camera approaches the target.

WIPO 2009/087543, System and Method for Navigating a Remote Control Vehicle Past Obstacles, to Rafael Advanced Defense Systems, Ltd., Haifa Israel (referred to as '543) teaches processing techniques for displaying a representation of a vehicle at a location within a prior image. Current images are processed to derive information on the current location of the vehicle relative to a previous or pre-defined viewpoint). This information is used to display a representation of the vehicle on a previously captured (prior) image having a viewpoint corresponding to the previously captured image (corresponding viewpoint) other than the current viewpoint. The pre-defined viewpoint of '543 is a fixed viewpoint. In contrast, in a preferred implementation of the current embodiment the current viewpoint changes in real-time. '543 also teaches methods for substituting into the prior image a suitably scaled and warped tile based on the current image. The current image is processed to derive information on the location of the vehicle, and current location information is used with prior location information for warping the current image to appear to be from a similar viewing angle as the prior image. While the techniques of '543 are useful for the intended application, innovative techniques are needed for matching previously captured images from the viewpoints corresponding to the previously captured images (corresponding viewpoints) to a detailed image from a current viewpoint.

PCT/IB2010/054137, A System And Method For Assisting Navigation Of A Vehicle In Circumstances Where There Is A Possibility Of The View Being Obscured, to Rafael Advanced Defense Systems, Ltd., Haifa Israel (referred to as '137), teaches processing techniques for using augmented reality (AR, also known as virtual reality VR), to provide information to a user. Current images are digitally processed and augmented by the addition of computer graphics. Prior images having viewpoints corresponding to the previously captured images (corresponding viewpoints) other than the current viewpoint are processed to provide information on objects of interest in a scene. The current image is processed in real-time and augmented with objects of interest from previous images. While the techniques of '137 are useful for the intended application, innovative techniques are needed for matching previously captured images from corresponding viewpoints to a detailed image from a current viewpoint.

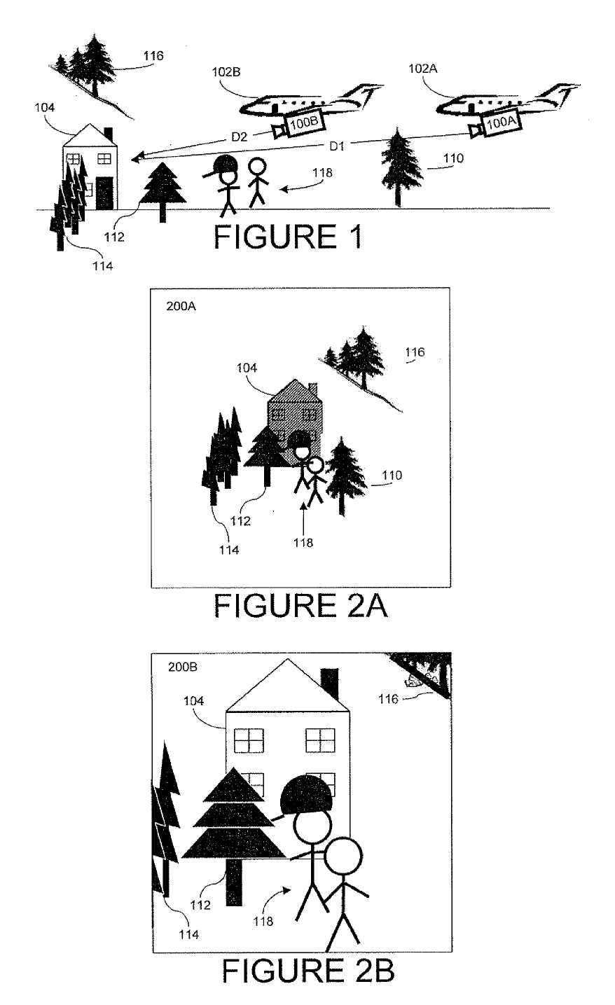

Referring now to the drawings, FIG. 1 is a diagram of sensor approaching a target. In this non-limiting example, a dual FOV image is generated according to one implementation of the current embodiment. A sensor, in this case camera 100A having a NFOV, is associated with a moving platform, in this case airplane 102A and is at a first distance D1 from target 104. As airplane 102A moves toward target 104, at a second distance D2 for clarity airplane 102A is shown in a new location as airplane 102B with camera 100A shown as camera 100B. Alternatively, camera 100A and camera 100B can be different cameras. Objects in the target area include far tree 110, near tree 112, group of trees 114, hillside 116, and people 118.

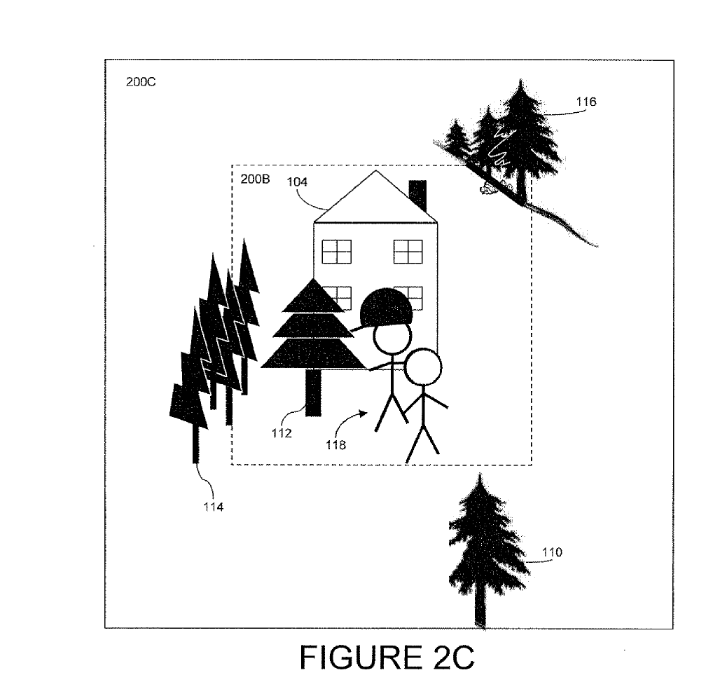

FIG. 2A is a diagram representing a first image 200A captured with camera 100A from a viewpoint corresponding to the first image 200A (corresponding viewpoint). FIG. 2B is a diagram representing a second image 200B captured with camera 100B from a current viewpoint. FIG. 2C is a representation of a dual FOV image 200C generated based on first image 200A and second image 200B. Camera 100A/100B has a NFOV, but as described above, since first image 200A is captured (sampled) from a first distance D1 that is relatively farther away from target 104 than second distance D2 from which second image 200B is captured (sampled), first image 200A provides a large footprint image of the target 104 while second image 200B provides a small footprint image of the target 104.

Note that the view of target 104 in images 200A, 200B, and 200C is 90 degrees from the representation of target 104 in FIG. 1, as the images are taken from the viewpoint of camera 100A/100B. For example, the front door of target 104 is visible in FIG. 1, but no side-door is visible in FIGS. 2A-2C. In first image 200A, the WFOV includes target 104 and all objects in the target area, as first image 200A is captured from a relatively far first distance D1 from the target 104. In second image 200B, the NFOV includes a subset of objects in the target area, as second image 200B is captured from a relatively closer second distance D2 to the target 104. While the resolution of each image is high due to the use of a NFOV camera, the resolution of objects in first image 200A is low due to the larger first distance D1 from camera 100A to target 104. This lower object resolution is shown in first image 200A as target 104 being grayed-out and lack of detail in near tree 112 and group of trees 114. In comparison, the resolution of the same objects in second image 200B is high due to the smaller second distance D2 from camera 100A to target 104. This higher object resolution is shown in second image 200B as target 104 being shown in detail and details in near tree 112, group of trees 114, and hillside 116. While two objects, group of trees 114 and hillside 116, are more detailed due to the high resolution and closer second distance D2, the NFOV does not capture all of the two objects, and the two objects are shown partially in second image 200B. To assist in describing and understanding the current example, additional details of hillside 116 are shown in FIGS. 2B and 2C. The additional details, including distinctions between individual trees (outlines) and rocks on hillside 116, are not visible in first image 200A, captured from a relatively far first distance D1 but are visible in second image 200B captured from a relatively closer second distance D2. Additionally, far tree 110 is not visible in second image 200B. As can be seen, while second image 200B provides a higher resolution image of a target area, second image 200B lacks the orientation information provided by first image 200A, as a user approaches a target and/or orientation of the target in relation to the area surrounding the target.

Referring to FIG. 2C, dual FOV image 200C is based on the high-resolution second image 200B and the current viewpoint. A new large footprint image is generated based on the first image 200A by rendering first image 200A so as to appear as a continuation of the second image 200B and the current viewpoint. Second image 200B and the new generated large footprint image are combined to generate dual FOV image 200C. The dual FOV image 200C provides both higher resolution of objects, as described in reference to second image 200B, and the orientation information as described in reference to first image 200A. The central image 200B provides higher resolution of the target, while the portion of 200C surrounding 200B provides relatively lower resolution orientation information. Examples of orientation information in dual FOV image 200C include group of trees 114, hillside 116 shown fully, and far tree 110 is visible.

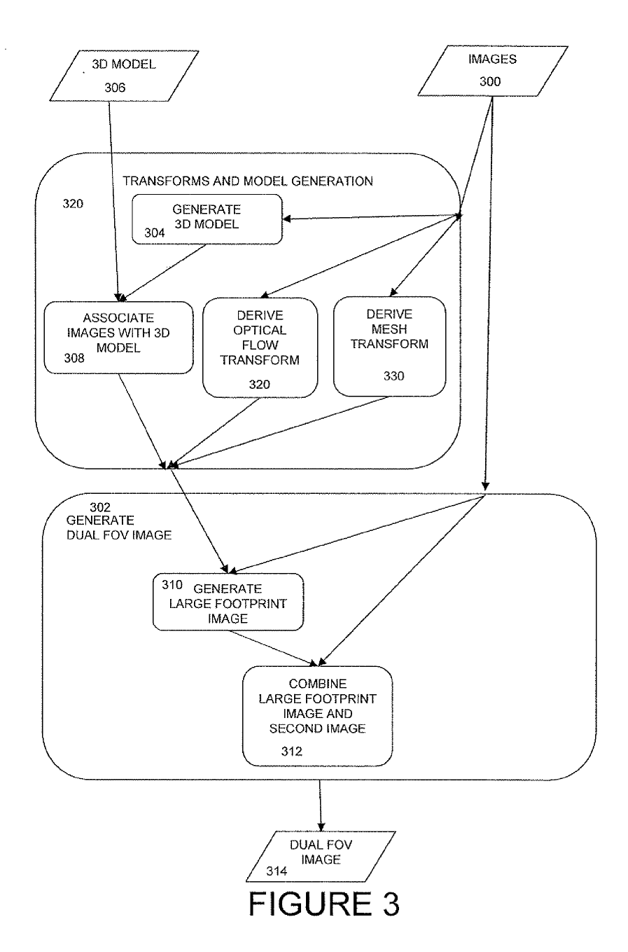

Referring to FIG. 3 a flowchart of a method for generating an image of a target area is shown. A plurality of images 300 is provided. In a preferred implementation, the images 300 are provided in real-time by a video camera. Alternative implementations include, but are not limited to, providing images from one or more still cameras, one or more sensors, and previously captured images from storage. The plurality of images 300 includes at least a first image of the target area sampled at a first distance from an imaging device to the target area. The first image has a viewpoint corresponding to the first image (corresponding viewpoint) from which the target is viewed and from which the first image of the target is captured. The plurality of images 300 also includes at least a second image of the target area sampled at a second distance from the imaging device to the target area. The second distance is less than the first distance. The second image has a current viewpoint from which the second image of the target is captured and a first field of view (FOV). As the first distance is different from the second distance, the viewpoint corresponding to the previously captured image (corresponding viewpoint) is different from the current viewpoint. As subsequent images are captured in real-time, the method repeatedly uses the most recently captured image as the second image, hence the current viewpoint changes (constantly changes in real-time). Note that for clarity the current method is generally described using a single first image and single second image. It will be obvious to one skilled in the art that the current description can be extended to using multiple first images and/or multiple second images.

A dual field of view (FOV) image 314 of the target area is generated 302 as a combination 312 of the second image and a generated 310 large footprint image. The generated large footprint image is based on at least the first image rendered so as to appear as a continuation of the second image with the current viewpoint. The large footprint image has an effective FOV greater than the first FOV of the second image. Note that the first image is preferably captured with a NFOV sensor that provides data that is sufficient for generating a large footprint image, where the large footprint image is similar to an image captured with a conventional WFOV sensor for a camera position relatively closer to the target (the current viewpoint). The captured first image has a viewpoint corresponding to the previously captured image (corresponding viewpoint), while the generated large footprint image is from the current viewpoint. In a preferred implementation both the first and second images are captured with the same fixed NFOV imaging device, and at least the first image and the second image are sampled using substantially the same field of view (FOV).

Referring back to FIGS. 2A-2B, a first image 200A is a captured with a NFOV sensor and provides a large footprint image of the target area, relative to second image 200B which is also a captured with a NFOV sensor, but provides a small footprint image of the target area since second image 200B is captured from a closer distance to target 104 than first image 200A. Referring back to FIG. 2C, first image 200A has been appropriately rendering so as to appear as a continuation of second image 200B, as shown by the area between the outer solid square and inner dashed square boxes. First image 200A has been appropriately generated, scaled, and/or warped to appear as a continuation of second image 200B, as can be seen by the representation in dual FOV image 200C of objects including far tree 110, group of trees 114, and hillside 116.

The generated large footprint image adjoins one or more edges of the second image, typically surrounding the second image and providing WFOV orientation information related to the target to assist users. Depending on the application, the extent (size) of the desired WFOV around the target is determined. Portions of at least a first image are processed to provide image information so as to appear as a continuation the second image and sufficient to fill in the dual FOV image from the edges of the second image to the edges of the desired WFOV around the target.

Rendering so as to appear as a continuation includes a combination of image registration, correcting geometric deformations, and eliminating seams between combined images. The complexity of rendering so as to appear as a continuation depends on a variety of factors, including but not limited to the type of sensor being used, the distances from images to the target, the structure of the target, the target area (the area around the target), and specifics of the application such as desired resolution, processing abilities, and limitations. As described above in reference to conventional processing techniques, as a camera gets closer to a target, the three-dimensional (3D) realities of the scene must be taken into account to produce an accurate combined image. Conventional global transforms are not sufficient for handling the 3D realities.

The following description includes techniques that can be used to implement rendering so as to appear as a continuation and generation of a dual FOV image. It is foreseen that other techniques can be developed and used based on future research and implementations for specific applications.

While the camera is moving toward the target and capturing images, the images can be used to build a model of the target area. The model initially includes low-resolution information, and can be updated as subsequent captured images provide further and/or more detailed images of the target area. Captured images can be registered to the model and/or stored for future and/or additional registration. The model and registered images from corresponding viewpoints can be used to generate a large footprint image of the target from a current viewpoint, which is then used to generate a dual FOV image of the target area.

Additional and optional techniques can be used to provide and/or support generation 310 of a large footprint image. Referring again to FIG. 3, the plurality of images 300 and/or a 3D model 306 can be used by one or more transforms and model generation 320 techniques, as described below.

In one implementation of the current embodiment, a three-dimensional (3D) model of the target area is used. Referring again to FIG. 3, a 3D model can be generated 304 from the plurality of provided images 300 or a pre-determined 3D model can be supplied 306 from storage. A non-limiting example of a pre-determined 3D model is a digital terrain map (DTM). Optionally a pre-determined 3D model can be updated based on the plurality of provided images (for clarity, not shown in the flowchart). Techniques for generation of 3D models from images are known in the art, including using structure from motion (SFM) and bundle adjustment (BA) techniques. One skilled in the art will be able to select and implement techniques appropriate for a specific application.

Each of the plurality of images 300 is associated 308 with a 3D model of the target area. The 3D model and associated images sampled corresponding viewpoints are used to generate 310 a large footprint image from a current viewpoint. The generated large footprint image can then be combined 312 with a second image to generate a dual FOV image. In this case, the central, detailed portion of the dual FOV image is based on the second image, and the portion of the dual FOV image surrounding the second image is based on the 3D model. Alternatively, the dual FOV image can be generated directly from the 3D model using the associated images. Techniques for generation of images from 3D are known in the art, and one skilled in the art will be able to select and implement techniques appropriate for a specific application.

In another implementation of the current embodiment, an optical flow technique is used to derive an “optical flow transform” 320 between the second image and the first image. The optical flow transform can then be used to generate 310 the large footprint image. A non-limiting example of using an optical flow technique includes using a first image that provides a less detailed large footprint image (WFOV of the target area) and a second image that provides a more detailed small footprint image (NFOV of the target area). Applying appropriate optical flow algorithms can find an optical flow transform mapping the pixels of the more detailed second image to the pixels of the less detailed first image. Once an optical flow transform is available to correlate the small footprint image (NFOV) to the large footprint image (WFOV), the optical flow transform can be used to derive an inverse optical flow transform, which can be used to render the large footprint image so as to appear as a continuation of the small footprint image. The inverse optical flow transform is now extrapolated and used to render portions of the large footprint image so as to appear as a continuation surrounding the second image in the dual FOV image. Optical flow techniques are known in the art, and one skilled in the art will be able to select and implement techniques appropriate for a specific application.

In another implementation of the current embodiment, fiducial points in the first and second images are used to derive a “mesh transform” 330. The mesh transform can then be used to generate 310 the large footprint image. The first image and second image are analyzed to derive a first set and second set, respectively, of corresponding fiducial points (points in each image with high entropy). The fiducial points are used to derive a mesh transform, also known as a graph transform, between the first and second images. Once a mesh transform is available to render the large footprint image (WFOV of the first image) so as to appear as a continuation of the small footprint image (NFOV of the second image), the mesh transform can be used to rendering so as to appear as a continuation portions of the first image to surround the second image in the dual FOV image.

A related technique includes using groups of fiducial points in each image to define a polygon. For example, using three fiducial points from the first image defines a triangular area in the first image. Using a multitude of groups defines a multitude of polygons. The polygons can then be used to derive a mesh transform between the first image and second image. While any polygon can be used, a preferred implementation is to use a triangle, as this allows a piecewise linear transform to be used, which is not always possible with other polygons. Using polygons can reduce the processing from 1000's of fiducial points to 100's of polygons. Techniques for producing mesh transforms from images are known in the art, and one skilled in the art will be able to select and implement techniques appropriate for a specific application.

Generation of the dual FOV image should preferably take into account related factors, including but not limited to illumination, parameters of the image capture device (such as distortions due to the lens), and defective pixels.

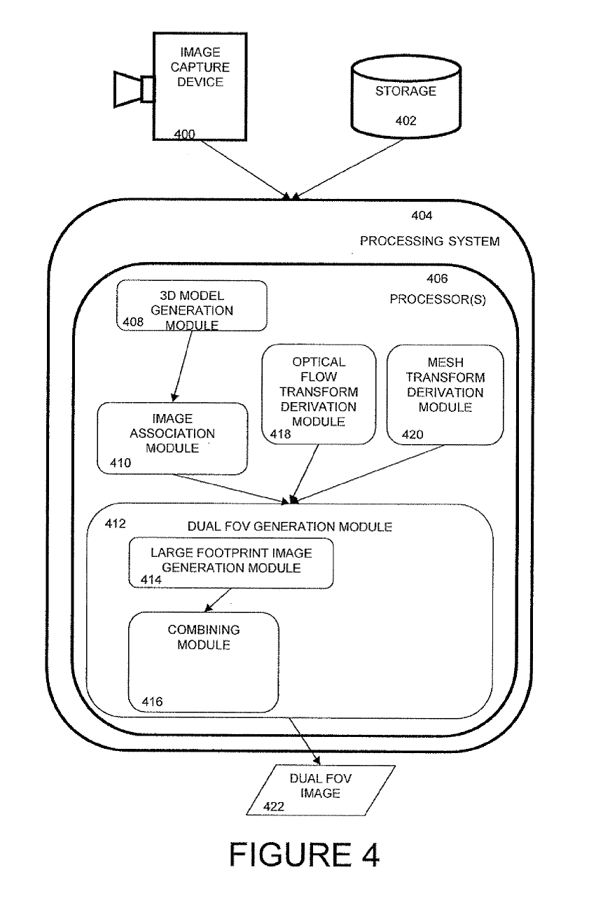

Referring to FIG. 4, a diagram of a system for generating an image of a target area, an image source provides a plurality of images of the target area. Images sources include, but are not limited to, one or more video cameras 400 capturing real-time images, a plurality of sensors (as described above), and at least one image storage device 402. The plurality of images includes at least a first image of the target area sampled at a first distance from an imaging device to the target area, the first image having a viewpoint corresponding to the previously captured first image (corresponding viewpoint), and a second image of the target area sampled at a second distance from the imaging device to the target area, the second distance being less than the first distance, the second image having a current viewpoint and a first field of view (FOV). A processing system 404 includes at least one processor 406. The processing system is configured with a dual FOV generation module 412, a large footprint image generation module 414, and a combining module 416. The large footprint image generation module 414 generates a large footprint image based on at least the first image rendering so as to appear as a continuation of the second image with the current viewpoint, the generated large footprint image having an effective FOV greater than the first FOV. The combining module 416 combines the generated large footprint image with at least the second image. Hence, the dual FOV generation module 412 generates a dual field of view image 422 as a combination of the second image and a large footprint image based on at least the first image rendering so as to appear as a continuation of the second image at the current viewpoint. Preferably, the at least first image is captured with a NFOV sensor and the second image is captured with a NFOV sensor. Most preferably, at least the first and the second image are sampled using substantially the same narrow field of view (NFOV).

Optionally, a three-dimensional (3D) model of the target area is used. The processing system is configured with a 3D model generation module 408 to generate a 3D model from the plurality of provided images. Alternatively, a pre-determined 3D model can be supplied from storage 402. Optionally a pre-determined 3D model from storage 402 can be updated based on the plurality of provided images (for clarity, not shown in the flowchart), for example from real-time video image capturing 400. Each of the plurality of images is associated 410 with a 3D model of the target area. The 3D model and associated images from corresponding viewpoints are used by the large footprint image generation module 414 to generate a large footprint image from a current viewpoint. The generated large footprint image can then be combined by the combining module 416 with a second image to generate a dual FOV image 422. Alternatively, the dual FOV image can be generated directly from the 3D model using the associated images. As described above, techniques for generation of images from 3D are known in the art, and one skilled in the art will be able to select and implement techniques appropriate for a specific application.

In another implementation of the current embodiment, the processing system 404 is configured with an optical flow transform derivation module 418 that derives an optical flow transform between the second image and the first image. The processing system is further configured to generate the large footprint image using the optical flow transform, as described above.

In another implementation of the current embodiment, the processing system 404 is configured with a mesh transform derivation module 420 that uses a first set of fiducial points in the first image with a second set of fiducial points in the second image to derive a mesh transform. The processing system is further configured to generate the large footprint image using the mesh transform, as described above.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

It will be appreciated that the above descriptions are intended only to serve as examples, and that many other embodiments are possible within the scope of the present invention as defined in the appended claims.

What is claimed is:

1. A method for generating an image of a target area, comprising the steps of:
(a) providing a plurality of images of the target area, wherein said plurality of images includes:
(i) at least a first image of the target area sampled at a first distance from an imaging device to the target area, said first image having a corresponding viewpoint; and
(ii) a second image of the target area sampled at a second distance from said imaging device to the target area, said second distance being less than said first distance, said second image having a current viewpoint and a first field of view (FOV); and
(b) generating a dual field of view image as a combination of:
(i) said second image; and
(ii) a generated large footprint image based on at least said first image rendered so as to appear as a continuation of said second image with said current viewpoint, said generated large footprint image having an effective FOV greater than said first FOV.

2. The method of claim 1 wherein at least said first image is sampled with a narrow field of view (NFOV) sensor and said second image is sampled with a NFOV sensor.

3. The method of claim 1 wherein at least said first image and said second image are sampled using substantially the same field of view (FOV).

4. The method of claim 1 wherein each of said plurality of images is associated with a three-dimensional (3D) model of the target area and the step of generating a dual field of view image includes using said 3D model to provide said generated large footprint image.

5. The method of claim 4 wherein said 3D model is generated from said plurality of images.

6. The method of claim 4 wherein said 3D model is a pre-determined model of the target area.

7. The method of claim 6 wherein said 3D model is a digital terrain map (DTM).

8. The method of claim 1 wherein an optical flow technique is used to derive an optical flow transform between said second image and said first image, and the step of generating a dual field of view image includes using said transform to provide said generated large footprint image.

9. The method of claim 1 wherein a first set of fiducial points in said first image are used with a second set of fiducial points in said second image to derive a mesh transform, and the step of generating a dual field of view image includes using said mesh transform to provide said generated large footprint image.

10. A system for generating an image of a target area, comprising:
(a) an image source providing a plurality of images of the target area, wherein said plurality of images includes:
(i) at least a first image of the target area sampled at a first distance from an imaging device to the target area, said first image having a corresponding viewpoint; and
(ii) a second image of the target area sampled at a second distance from said imaging device to the target area, said second distance being less than said first distance, said second image having a current viewpoint and a first field of view (FOV); and
(b) a processing system including at least one processor, said processing system configured to generate a dual field of view (FOV) image as a combination of:
(i) said second image; and
(ii) a generated large footprint image based on at least said first image rendered so as to appear as a continuation of said second image with said current viewpoint, said generated large footprint image having an effective FOV greater than said first FOV.

11. The system of claim 10 wherein said image source includes a video camera capturing real-time images.

12. The system of claim 10 wherein said image source includes a plurality of sensors.

13. The system of claim 10 wherein said image source includes at least one image storage device.

14. The system of claim 10 wherein at least said first image is sampled with a narrow field of view (NFOV) sensor and said second image is sampled with a NFOV sensor.

15. The system of claim 14 wherein at least said first and said second image are sampled using substantially the same field of view (FOV).

16. The system of claim 10 wherein said processing system is configured with an image association module that associates each of said plurality of images with a three-dimensional (3D) model of the target area, and said processing system is configured to generate said generated large footprint image using said 3D model.

17. The system of claim 16 wherein said 3D model is generated from said plurality of images.

18. The system of claim 16 wherein said 3D model is a pre-determined model of the target area.

19. The system of claim 16 wherein said 3D model is a digital terrain map (DTM).

20. The system of claim 10 wherein said processing system is configured with an optical flow transform derivation module that derives a optical flow transform between said second image and said first image, and said processing system is configured to generate said generated large footprint image using said optical flow transform.

21. The system of claim 10 wherein said processing system is configured with a mesh transform derivation module that uses a first set of fiducial points in said first image are with a second set of fiducial points in said second image to derive a mesh transform, and said processing system is configured to generate said generated large footprint image using said mesh transform.
